(19) United States
(12) Patent Application Publication
(10) Pub. No.: US 2004/0053085 A1
(43) Pub. Date: Mar. 18, 2004

(54) Hydrogen management system for a fuel cell

(76) Inventors: Stuart I. Smedley, Escondido, CA (US); Stephen R. des Jardins, Encinitas, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/660,840

(22) Filed: Sep. 12, 2003

Related U.S. Application Data
(60) Provisional application No. 60/410,581, filed on Sep. 12, 2002.

(51) Int. Cl. H01M 8/06; C01B 3/08

(52) U.S. Cl. 429/19; 423/657

(57) ABSTRACT

Improved containers have therein fuel, such as metal, in contact with an aqueous electrolyte. At least one recombination catalyst separate from the electrolyte is in gas communication with the container and, in some embodiments, a separate oxygen source supplies oxygen for the reaction with hydrogen gas. Generally, the recombination catalyst catalyzes the reaction of hydrogen and oxygen to form water. For example, the recombination catalyst can be attached to the top of the container, located in a cavity formed in the top of the container, provided to a portion of a vent connected to the container, or a combination thereof. In some embodiments, the oxygen source can be ambient air from outside the container or can be supplied from a suitable container.

### CROSS-REFERENCE TO RELATED APPLICATIONS

The current application claims the benefit of priority from U.S. provisional application filed on Sep. 12, 2002, entitled “Hydrogen Management System for a Zinc Regenerative Fuel Cell” having Serial No. 60/410,581, which is incorporated herein by reference.

### FIELD OF THE INVENTION

The invention relates to hydrogen management systems for electrochemical cells. In particular, in some embodiments, the invention relates to fuel containers for non-hydrogen-based fuel cells having at least one recombination catalyst suitable for catalyzing the reaction of hydrogen and oxygen to form water. Additionally, the invention pertains to methods for recombining hydrogen gas inside a fuel container or other components of a fuel cell system.

### BACKGROUND OF THE INVENTION

In general, a fuel cell is an electrochemical device that can convert chemical energy stored in fuels such as hydrogen, methane, zinc, aluminum and the like, into useful energy. A fuel cell generally comprises a negative electrode, a positive electrode, and a separator within an appropriate container. Fuel cells operate by utilizing chemical reactions that occur at each electrode. In general, electrons are generated at the anode and current flows through an external circuit to the cathode where a reduction reaction takes place. The electrochemical potential difference between the two electrodes can be used to drive useful work in the external circuit. For example, in one embodiment of a fuel cell employing metal, such as zinc, iron, lithium and/or aluminum, as a fuel and potassium hydroxide as the electrolyte, the oxidation of the metal to form an oxide or a hydroxide takes place at the anode. In commercial embodiments, several fuel cells are usually arranged in series, or stacked, in order to create larger voltages. For commercially viable fuel cells, it is desirable to have electrodes that can function within desirable parameters for extended periods of time on the order of 1000 hours or greater.

A fuel cell is similar to a battery in that both generally have a positive electrode, a negative electrode and electrolytes. However, a fuel cell is different from a battery in the sense that the fuel in a fuel cell can be replaced without disassembling the cell to keep the cell operating. In some embodiments, a fuel cell can be coupled to, or contain, a fuel regeneration unit which can provide the fuel cell with regenerated fuels.

In some fuel cells, the fuel can be stored in a container that is connected to the electrochemical cell stacks. Generally, the fuel is transported to the cells in an aqueous electrolyte such as, for example, potassium hydroxide solution. Under certain conditions, the fuel can react with the water in the electrolyte solution to form hydrogen gas. This reaction is sometimes referred to as corrosion of the fuel. The corrosion reaction is undesirable because it can produce hydrogen gas within the fuel cell system and also removes water from the electrolyte solution.

Fuel cells are a particularly attractive power supply because they can be efficient, environmentally safe and completely renewable. MetaVair fuel cells can be used for both stationary and mobile applications, such as all types of electric vehicles. Fuel cells offer advantages over internal combustion engines, such as zero emissions, lower maintenance costs and higher specific energies. Higher specific energies associated with selected fuels can result in weight reductions. In addition, fuel cells can give vehicle designers additional flexibility to distribute weight for optimizing vehicle dynamics.

### SUMMARY OF THE INVENTION

In one aspect, the invention pertains to a hydrogen management system comprising a container having therein metal in contact with an aqueous electrolyte and at least one recombination catalyst separate from the aqueous electrolyte. In some embodiments, the catalyst is suitable for catalyzing the reaction of hydrogen and oxygen to form water. The hydrogen management system can further comprises at least one oxygen source connected to the container that provides oxygen to the interior of the container. Generally, hydrogen gas present in the container can contact the recombination catalyst and combine with oxygen to from water.

In another aspect, the invention pertains to a fuel cell system comprising an electrochemical cell stack having at least one anode, at least one cathode, a separator, and a container having therein a non-hydrogen fuel suitable for electrochemical reactions in contact with an aqueous electrolyte. In some embodiments, the container comprises a flow inlet and a flow outlet coupled to the electrochemical cell stack to provide the non-hydrogen fuel and the electrolyte to the electrochemical cell stack. Generally, at least one recombination catalyst separate from the electrolyte is in gas communication with the container. The recombination catalyst generally is suitable for catalyzing the reaction of hydrogen and oxygen to form water. The fuel cell system can also comprise an oxygen source. Generally, hydrogen gas present in the container can contact the recombination catalyst and combine with oxygen to form water.

Additionally, the invention pertains to a method for managing hydrogen for an electrochemical cell fuel container, the method comprising reacting hydrogen gas and oxygen gas to form water. In this embodiment, the container comprises a non-hydrogen fuel and an aqueous electrolyte, and a recombination catalyst that catalyzes the reaction of hydrogen and oxygen to form water is in gas communication with the container.

### BRIEF DESCRIPTION OF THE FIGURES

FIG. 1 is a schematic side view of a container with a side wall made transparent to show the fuel, electrolyte and recombination catalyst contained within the container.

FIG. 2 is a side view of another embodiment of a container with a side wall made transparent to show the fuel, electrolyte and recombination catalyst.

FIG. 3 is a schematic view of a fuel cell system with a container having a recombination catalyst and an oxygen source.

FIG. 4 is a schematic view of a fuel cell system with a container having a recombination catalyst, an oxygen source and a regeneration unit.

FIG. 5 is a schematic view of an electrochemical cell stack designed for the continuous replenishment of a metal fuel, in which a sectional side view of an anode is shown in phantom lines.

FIG. 6 is a sectional view of the fuel cell of FIG. 6 showing a cathode, in which the section is taken along line 6-6 of FIG. 5.

FIG. 7 is a side view of a zinc electrolyzer, in which an exterior case is made transparent to show an anode and a cathode.

### DETAILED DESCRIPTION OF THE INVENTION

Improved containers contain fuel, such as metal, in contact with an aqueous electrolyte, at least one recombination catalyst separate from the electrolyte and, in some embodiments, an oxygen source. Generally, the recombination catalyst is suitable for catalyzing the reaction of hydrogen and oxygen to form water. Due to the presence of the recombination catalyst and the oxygen, hydrogen gas present in the containers can be combined with the oxygen to form water. The elimination of hydrogen gas can improve safety. Additionally, the water formed by the hydrogen and the oxygen can be provided to the electrolyte solution, which can reduce depletion of the electrolyte as a result of corrosion that forms hydrogen. The recombination catalyst can be attached, for example, near the top of the container, located in a cavity formed in the top of the container, provided to a portion of a vent connected to the container, positioned at other locations in vapor communication with the container, or a combination thereof. In some embodiments, the oxygen source can be ambient air from outside the container or can be supplied from a suitable container.

There are several types of fuels, i.e. reducing agents, typically employed in electrochemical cells including, for example, hydrogen, direct methanol and metal-based fuel systems. A metal-based fuel cell is an electrochemical cell that uses a metal, such as zinc particles, as fuel in the anode. In a metal fuel cell, the fuel is generally stored, transported and used in the presence of a reaction medium or electrolyte, such as a potassium hydroxide solution. The zinc metal is generally in the form of particles to allow for sufficient flow of the zinc fuel through the fuel cell. Specifically, in metal/air batteries and metal/air fuel cells, oxygen is reduced at the cathode, and metal is oxidized at the anode. In some embodiments, oxygen is supplied as air. For convenience, air and oxygen are used interchangeably throughout unless otherwise noted. In other embodiments, the oxidizing agent supplied to the cathode may be bromine gas or other suitable oxidizing agents. In some embodiments, the fuel compositions may further include additional additives, such as stabilizers and/or discharge enhancers.

In general, gas diffusion electrodes are suitable for catalyzing the reduction of gaseous oxidizing agents, such as oxygen, at a cathode of a metal fuel cell or battery. In some embodiments, gas diffusion electrodes comprise an active layer associated with a backing layer. The active and backing layers of a gas diffusion electrode are porous to gases such that gases can penetrate through the backing layer and into the active layer. However, the backing layer of the electrode is generally sufficiently hydrophobic to prevent diffusion of the electrolyte solution into or through the backing layer. The active layer generally comprises catalyst particles for catalyzing the reduction of a gaseous oxidizing agent, electrically conductive particles such as, for example, conductive carbon and a polymeric binder. Gas diffusion electrodes suitable for use in metal/air fuel cells are generally described in co-pending application Ser. No. 10/364,768, filed on Feb. 11, 2003, titled “Fuel Cell Electrode Assembly,” and in co-pending application Ser. No. 10/288,392, filed on Nov. 5, 2002, titled “Gas Diffusion Electrodes,” both of which are incorporated herein by reference.

In metal/air fuel cells that utilize zinc as the fuel, the following reaction takes place at the anodes:

Zn+4OH⁻→Zn(OH)₄²⁻+2e⁻ (1)

The two released electrons flow through a load to the cathode where the following reaction takes place:

$$\frac{1}{2} {O}_{2} + 2 {e}^{-} + {H}_{2} O \to 2 {OH}^{-} \qquad ( 2 )$$

The reaction product is the zincate ion, Zn(OH)₄²⁻, which is soluble in the reaction solution KOH. The overall reaction which occurs in the cell cavities is the combination of the two reactions (1) and (2). This combined reaction can be expressed as follows:

$$Zn + 2 {OH}^{-} + \frac{1}{2} {O}_{2} + {H}_{2} O \to {Zn ( OH )}_{4}^{2 -} \qquad ( 3 )$$

Alternatively, the zincate ion, Zn(OH)₄²⁻, can be allowed to precipitate to zinc oxide, ZnO, a second reaction product, in accordance with the following reaction:

Zn(OH)₄²⁻→ZnO+H₂O+2OH⁻ (4)

In this case, the overall reaction which occurs in the cell cavities is the combination of the three reactions (1), (2), and (4). This overall reaction can be expressed as follows:

$$Zn + \frac{1}{2} {O}_{2} \to ZnO \qquad ( 5 )$$

Under ambient conditions, the oxidation of zinc and reduction of molecular oxygen yields an open-circuit voltage potential of about 1.4V. For additional information on embodiments of a zinc/air battery or fuel cell, see for example U.S. Pat. Nos. 5,952,117; 6,153,329; and 6,162,555, which are incorporated by reference herein as though set forth in full.

Under certain conditions, corrosion of the fuel can occur. For example, the simplified reaction pathway that leads to zinc corrosion is shown below:

Zn+H₂O→ZnO+H₂ (6)

As shown in equation (6), the reaction involves the reduction of water to yield gaseous hydrogen and the oxidation of metallic zinc to the Zn (II) ion. The corrosion of fuels such as zinc can be undesirable because the hydrogen gas represents a safety hazard. Additionally, the generation of hydrogen within the plumbing of fuel cell systems can cause gas bubbles to accumulate in, for example, the pumps and other points where system operation may be impeded. The accumulation of gas bubbles in the pumps of the fuel cell can result in the pumps losing their pumping ability. Furthermore, the generation of hydrogen gas removes water from the electrolyte solution, which can reduce the amount of energy the fuel cell can produce. Thus, it is generally desirable to recombine or remove the hydrogen gas present in a fuel cell container and/or a fuel cell system and thereby to replace the water. As described herein, the build up of hydrogen gas in a fuel cell can be reduced by providing a fuel container with an oxygen source and a recombination catalyst suitable for catalyzing the reaction of hydrogen and oxygen to form water.

Fuel Containers

The fuel containers of the present disclosure generally comprise at least one recombination catalyst suitable for catalyzing the reaction of hydrogen and oxygen to form water, wherein the recombination catalyst is separate from the fuel and electrolyte solution present in the container. In some embodiments, a head space can be provided at the top of the container, and the catalyst can be in the head space or a space in gas communication with the head space. For example, a recombination catalyst can be located inside the container, in a vent or passage connected to the container, or a combination thereof. A fuel container can further comprise at least one oxygen source, which can provide oxygen to the container to react with any hydrogen present in the container. The oxygen source can be, for example, an opening to the ambient atmosphere, an air or oxygen tank connected to the container, a regeneration unit, or a combination thereof. In some embodiments, the container may further comprise a vent with a pressure sensitive valve for venting gases from the container if a certain pressure is exceeded.

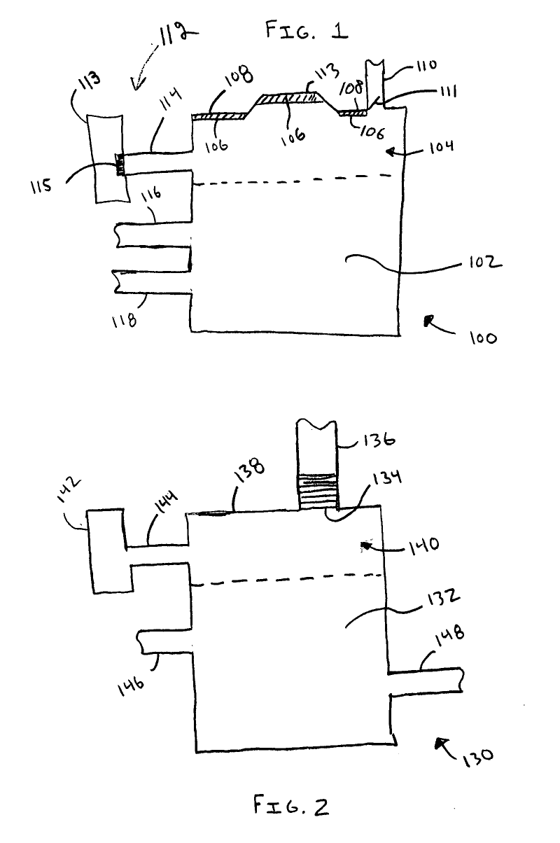

FIG. 1 shows fuel container 100 having a metal fuel and electrolyte mixture 102 contained within container 100. As shown in FIG. 1, in some embodiments, fuel and electrolyte mixture 102 fill only a portion of container 100, which leaves a head space 104 at the top of container 100 between fuel and electrolyte mixture 102 and top surface 108. In some embodiments, a recombination catalyst 106 separate from fuel and electrolyte mixture 102 can be located in head space 104, such as near the top surface 108 of container 100. In other embodiments, recombination catalyst 106 may be located on a side wall of container 100. Additionally or alternatively, a cavity 113 can be formed adjacent head space 104, such as along top surface 108 of container 100, and at least one recombination catalyst 106 can be located in cavity 113. In some embodiments, a gas permeable cover may be positioned across the entrance of cavity 113 such that the gas permeable cover defines the lower boundary of cavity 113. In further embodiments, recombination catalyst 106 may contact electrolyte mixture 102. In some embodiments, catalyst 106 can be sintered onto a porous ceramic structure to hold the catalyst particles in a fixed format that can be held in a desired position within container 100 by plastic mountings, such as brackets, frames and/or the like. Although FIG. 1 shows an embodiment with a single cavity located along top surface 108, other embodiments can comprise a plurality of cavities, wherein at least a portion of the plurality of cavities contain at least one recombination catalyst 106. The Generally, the recombination catalyst is a catalyst suitable for catalyzing the reaction of oxygen with hydrogen to form water. In some embodiments, vent 110 provides a pathway to expel gas from the container, including, for example, any hydrogen gas that does not recombine to form water. In one embodiment, vent 110 can comprise a pressure sensitive valve 111 that vents hydrogen and other gases that exceed a particular pressure.

Fuel container 100 can further comprise oxygen source 112, which can provide oxygen to container 100. In one embodiment, oxygen source 112 comprises an inlet 114 and a tank 113 or other suitable container containing oxygen, which delivers oxygen via oxygen inlet 114. Additionally or alternatively, oxygen source may comprise a valve or the like that allows controlled introduction of ambient air to enter container 100. In some embodiments, a pump 115 can be associated with oxygen source 112 to facilitate the flow of oxygen into container 100. Additionally, container 100 can comprise flow outlet 116 and flow inlet 118, which provide a pathway for circulating fuel and electrolyte mixture 102 to an electrochemical cell stack or the like.

Referring to FIG. 1, in this embodiment, hydrogen gas located in container 100 can accumulate in head space 104, and oxygen gas can diffuse and/or be pumped into head space 104 from oxygen source 112. The hydrogen and oxygen in the head space 104 can contact recombination catalyst 106 located in container 100 and recombine to from water. Additionally, hydrogen and/or oxygen molecules that do not recombine to form water can be vented through vent 110 to the ambient atmosphere. Thus, container 100 provides for both recombination and/or removal of hydrogen gas present inside the container.

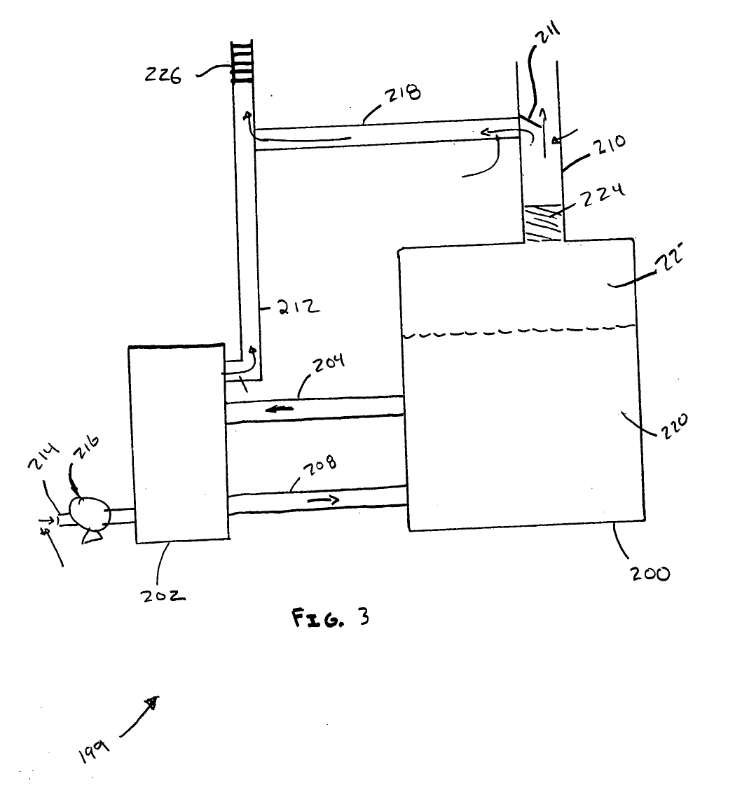

FIG. 2 shows another embodiment of a fuel container 130 having a metal fuel and electrolyte mixture 132 contained within container 130. In this embodiment, a recombination catalyst 134 can be located in a portion of vent 136. Generally, metal fuel and electrolyte mixture 132 only fills a portion of container 130, such that a head space 140 can be created along the top of container 130. Additionally or alternatively, recombination catalyst can also be located within the container's head space 140. In some embodiments, an oxygen source can be connected to container 130 to provide oxygen to head space 140 of container 130. The oxygen source can comprise an oxygen tank 142 and an oxygen inlet 144, a valve in vent 136 that permits ambient air to enter container 130, or a combination thereof. Generally, container 130 comprises flow inlet 146 and flow outlet 148, which can provide a pathway for circulating fuel and electrolyte mixture 132 to an electrochemical cell stack or other components of a fuel cell system. In this embodiment, hydrogen gas located in container 130, as well as oxygen provided to container 130 from one or more oxygen sources, can accumulate in head space 140, contact recombination catalyst 134 located in vent 136 and recombine to form water. Furthermore, hydrogen and oxygen gas that does not recombine into water can exit container 130 via vent 136.

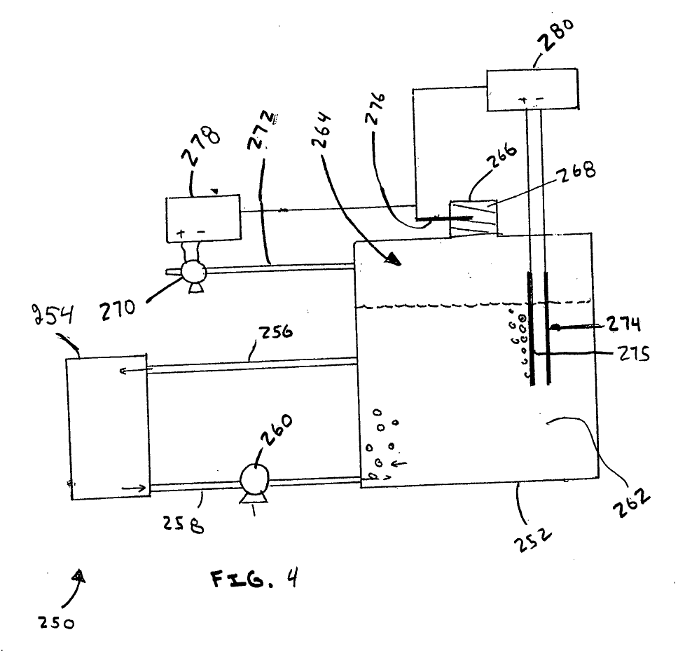

Referring to FIG. 3, an embodiment of a fuel cell system 199 is shown comprising fuel storage container 200, electrochemical cell stack 202, flow outlet pipe 204, flow inlet pipe 208 and vent 210. Fuel cell system 199 can further comprise cell stack exhaust 212, cell stack air inlet 214 and cell stack air pump 216. As shown in FIG. 3, electrochemical cell stack 202 is connected to fuel storage container 200 via flow pipes 204, 208, which provide a flow pathway for fluids between stack 202 and fuel container 200. In this embodiment, air can be pumped into electrochemical cell stack 202 through air inlet 214, and exit stack 202 through exhaust pipe 212. Vent 210 is connected to fuel storage container 200 and provides a flow pathway for gases, such as hydrogen, located within fuel container 200 to be released from the container. In some embodiments, at least one recombination catalyst 224 can be located in vent 210 suitable for catalyzing the reaction of hydrogen and oxygen to form water. Fuel cell system 199 can further comprise connection pipe 218, which provides a flow path between vent 210 and cell stack exhaust 212. Additionally or alternatively, at least one recombination catalyst 226 may be located in cell stack exhaust 212, above connection pipe 218. Generally, fuel container 200 contains a metal fuel and electrolyte solution 220 that fills only a portion of fuel container 200, which creates a head space 222 at the top portion of fuel storage container 200.

As shown in FIG. 3, fuel container 200 is connected to electrochemical cell stack 202 by pipes 204, 208, however, in other embodiments fuel container 200 may be connected to a container having fuel regeneration unit or to one or more electrochemical cell stacks. A valve 211 can be positioned in vent 210 to regulate the flow of hydrogen gas and other fluids to connection pipe 218. In this embodiment, hydrogen generated or present in container 200 can be vented though safety vent 210 to the atmosphere and/or can be channeled via connection pipe 218 to cell stack exhaust 212, where the hydrogen can combine with air existing cell stack 202, due to the presence of recombination catalyst 226, to form water. Alternatively, hydrogen gas present in container 200 can contact recombination catalyst 224 in vent 210 and recombine with oxygen that diffused into catalyst 224 through an opening in vent 210. Additionally, the flow of fuel and electrolyte between stack 202 and fuel container 200 via flow pipes 204, 208 may carry oxygen and hydrogen gas present in stack 202 into container 200, where the gases can contact recombination catalyst 224 in vent 210 and recombine to form water.

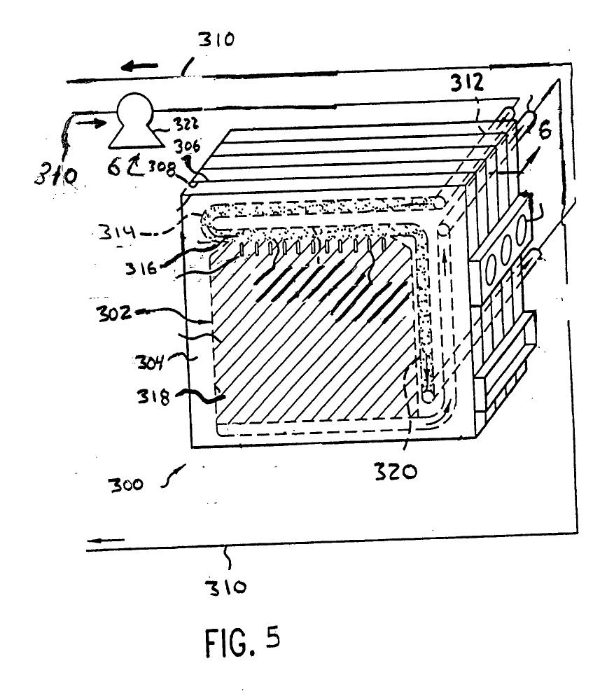

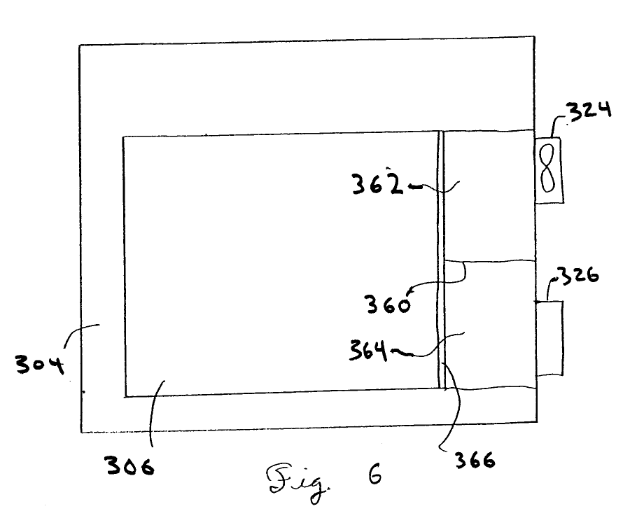

FIG. 4 shows another embodiment of a fuel cell system 250 comprising fuel container 252 connected to electrochemical cell stack 254 by flow outlet 256 and flow inlet 258. In some embodiments, flow pump 260 can be provided to circulate fuel and electrolyte solution 262 stored in container 252. Generally, fuel and electrolyte solution 262 fills only a portion of container 252, leaving a head space 264 along the top portion of container 252. In some embodiments, cavity 266 can be located in the top surface of container 252, adjacent head space 264. In one embodiment, cavity 266 comprises at least one recombination catalyst 268 suitable for catalyzing the reaction of hydrogen and oxygen to from water. As shown in FIG. 5, an air supply pump 270 can pump air into head space 264 through air inlet 272. Alternatively or additionally, as shown in FIG. 4, oxygen can provided to head space 264 by regeneration electrodes 274, 275. As will be described in detail below, regeneration electrodes 274, 275 can regenerate molecular oxygen and metal fuel particles from oxidized metal compounds. In some embodiments, as shown in FIG. 4, regeneration electrodes 274, 275 can be located inside container 252, however, in alternative embodiments regeneration electrodes 274, 275 can be located in a separate regeneration container and the regenerated oxygen can be provided to the fuel container 252 by pipes or the like.

As shown in FIG. 4, a temperature sensor 276 can be located inside container 252 to provide current temperature information to processor units connected to air pump power supply 278 and/or to regeneration electrodes power supply 280. Generally, power supplies 278, 280 can regulate the delivery and/or generation of oxygen to container 252 by adjusting the voltage supply to air supply pump 270 and/or to regeneration electrodes 274, 275. In some embodiments, the voltage supplied to air supply pump 270 and/or regeneration electrodes 274, 275 can be increased during higher temperature and discharge modes of operation, and decreased during standby and lower temperature modes of operation. As will be discussed below, regeneration electrodes 274, 275 can produce oxygen and fuel particles from solutions containing oxidized fuel compounds such as, for example, ZnO and/or Zn(OH)₄²⁻. Increasing the voltage to the regeneration electrodes can increase the amount of oxygen generated from oxidized fuel compounds. The amount of O₂ generated can be selected to be at least sufficient to react with the quantity of H₂ predicted to be generated at a particular temperature.

The containers of the present disclosure can be composed of any material suitable for use in electrochemical cell applications that are chemically inert with respect to the fuel and electrolyte contained within the container. Examples of suitable materials include metals, metal alloys, polymers, and combinations thereof. Suitable polymers include, for example, polyetheretherketone (PEEK), NORYL® (polyphenylene oxide/PPO, General Electric Polymers, which can be blended with polystyrene) and/or other thermoplastic polymers, such as polyethylene, polypropylene, poly(vinyl chloride), poly(tetrafluoroethylene), poly(vinylidene fluoride), and blends and copolymers thereof. One of ordinary skill in the art will recognize that no particular container shape is required by the present disclosure. In general, the size of the container will be guided by the fuel requirements of the corresponding electrochemical cell stack, or fuel cell system, that the container is intended to supply with fuel and electrolyte.

As described above, flow pipes can be connected to the body of the container to provide a flow pathway for fuel and electrolyte between the container and at least one electrochemical cell stack. The flow pipes can be composed of any material, such as a polymeric material, suitable for electrochemical cell applications that are chemically inert with respect to the fuel and electrolyte solution. Suitable polymers include, for example, PEEK, NORYL®, polyethylene, polypropylene, poly(vinyl chloride), poly(tetrafluoro-ethylene), poly(vinylidene fluoride), and blends and copolymers thereof. Additionally, the flow pipes can be composed of polymers such as, for example, PEEK, NORYL and combinations thereof. In some embodiments, the flow pipes can be composed of the same material as the body of the container, while in other embodiments the flow pipes can be composed of a different material than the container. In further embodiments, the container may comprise a plurality of inlet pipes and a plurality of outlet pipes connected to the container. In general, the number and size of the flow pipes will be guided by the design of the corresponding fuel cell system.

As noted above, the recombination catalyst is generally suitable for catalyzing the reaction of hydrogen and oxygen to form water. In one embodiment, the recombination catalyst can be platinum, however, other metals such as, for example, nickel, palladium or a combination thereof, can also be used. As described in detail below, the recombination catalyst can comprise a particulate material, which can be a catalyst material coated onto a substrate such as carbon. Suitable catalysts include, for example, elemental metal particles, metal compositions and combinations thereof. Suitable metals broadly cover all recognized metal elements of the periodic table and alloys thereof. Exemplary metals include without limitation, Fe, Co, Ag, Ru, Mn, Zn, Mo, Cr, Cu, V, Ni, Rh, and Pt. Suitable metal compositions include, for example, permanganates (e.g., AgMnO₄ and KMnO₄), metal oxides (e.g., MnO₂ and Mn₂O₃), decomposition products of metal heterocycles (e.g., iron tetraphenylporphyrin, cobalt tetramethoxyphenylporphyrin, cobalt complexes (e.g., tetramethoxyphenyl porphyrin (CoTMPP)), perovskites, cobalt pthalocynanine and iron pthalocynanine) and napthenates (e.g., cobalt napthenates and manganese napthenate) and combinations thereof. Elemental metals are un-oxidized metals in their zero oxidation state, i.e., M⁰. Suitable elemental metal particles include, for example, Ag, Pt, Pd, Ru, alloys thereof and combinations thereof. In general, the catalyst particles can be spherical, rod-shaped or any other suitable shape or combinations of shapes yielding an appropriate surface area.

Some metals for use as catalysts have a high cost. Therefore, cost savings can result from coating the elemental metal onto a less expensive particulate. For example, metals can be coated onto carbon black. In some embodiments, the catalysts comprise in the range(s) of at least about 80 weight percent carbon black and no more than about 20.0 weight percent metal, and in other embodiments from about 94.95 weight percent to about 99.9 weight percent carbon black, in the range(s) from about 0.1 weight percent to about 5.0 weight percent metal and in the range(s) from about 0.05 to about 5 weight percent nitrogen. To form the catalyst, carbon black is contacted with vapors of metal precursors and nitrogen precursors in a reducing environment. The metal may or may not be in elemental form and the carbon black may or may not be chemically bonded to metal and/or the nitrogen. The carbon black materials described above are also suitable for forming these catalyst materials. The carbon black-metal-nitrogen containing catalysts are further described in copending and commonly assigned U.S. patent application Ser. No. 09/973,490 to Lefebvre, entitled “Methods of Producing Oxygen Reduction Catalyst,” incorporated herein by reference.

At least one source of oxygen can be connected to the container to supply oxygen to react with any hydrogen present in the container. The term oxygen source is being used in the broad sense to include, for example, combinations of tanks, valves, regeneration electrodes, openings, piping systems and combinations thereof that permit oxygen to be introduced to, or generated in, a container. For example, in some embodiments, the oxygen source can comprise one or more valves that selectively permit ambient air from outside the fuel cell system to reach the container. In other embodiments, the oxygen source can comprise a tank of air and/or oxygen connected to the container. Additionally or alternatively, as will be described in detail below, the oxygen source can be regeneration electrodes that generate oxygen from oxidized fuel. In some embodiments, the regeneration electrodes can be located inside a fuel storage container, while in other embodiments the regeneration electrodes can be located in a separate regeneration container. The optional regeneration electrodes can be connected to a processor programmed to continuously provide oxygen to the container. Alternatively, the regeneration unit can periodically supply oxygen to the container. In one embodiment, oxygen can be pumped into the container from the oxygen source by an oxygen pump, while in other embodiments the oxygen may diffuse to the head space and/or recombination catalyst from the oxygen source.

As noted above, in some embodiments oxygen can be pumped into the head space of the container from one or more oxygen sources. The term pump is being used in its broad sense to include any mechanical device capable of applying a force against a fluid. Suitable pumps include, for example, fans, blowers, and the like and combinations thereof. In some embodiments, the pump can be programmed to provide oxygen approximately at the predicted rate of hydrogen evolution at a particular temperature. Alternatively, the oxygen pump can be programmed to operate continuously during discharge and higher electrolyte temperature modes of operation, and periodically during standby and lower electrolyte temperatures modes of operation.

The containers of the present disclosure generally contain a fuel and electrolyte mixture suitable for use in electrochemical cell applications. In some embodiments, the fuel is a particulate metal such as zinc, aluminum, iron, lithium, magnesium or a combination thereof. In one embodiment, the electrolyte can be an aqueous solution of potassium hydroxide. In some embodiments, the metal fuel can be present in a concentration of about 70 percent by weight, while in other embodiments the metal fuel can be present in a concentration from about 25 percent by weight to about 65 percent by weight. One of ordinary skill in the art will recognize that additional ranges of metal fuel concentration within these explicit ranges are contemplated and are within the scope of the present disclosure.

During operation, hydrogen gas produced by the corrosion reaction of a metal fuel and water in the cell stacks can be transported by the flowing electrolyte to the fuel and electrolyte container, where the hydrogen gas can accumulate in the head space of the container. Additionally, hydrogen gas produced by corrosion of the metal fuel and water in the container can also accumulate in the head space of the container. Hydrogen gas in present in the head space of the container can contact the recombination catalyst, which can be located adjacent to the head space, and recombine with oxygen provided to the container to form water. Hydrogen gas that does not recombine with oxygen to form water can optionally be expelled from the container through a vent. Water formed by the reaction of hydrogen gas and oxygen generally flows to the electrolyte within the container.

Fuel Cell System

An embodiment of an electrochemical cell stack 300 is shown in FIG. 5. As shown in FIG. 5, electrochemical cell stack 300 comprises a stack of one or more cells 302, each generally defining a plane and coupled together in series. Metal-air fuel cell 302 interfaces with a stack container 304. Each cell 302 includes an air positive electrode or cathode 306 that is positioned at one side of cell 302 and a zinc negative electrode or anode 308 that is positioned at the opposite side of cell 302. The cathode and anode are separated by an electrically insulating separator. Additionally, adjacent cells in electrochemical cell stack 300 can be coupled in series by bipolar plates, which can electrically connect the anode of a first cell with the cathode of an adjacent cell.

Electrochemical cell stack 300 can be incorporated into a electrochemical cell system, such as the systems shown in FIGS. 3 and 4, by connecting piping system 310 of electrochemical cell stack 300 to the flow inlet(s) and flow outlet(s) of an appropriate container. For example, metal fuel and electrolyte can be fed from a container, such as the containers described above in FIGS. 1-4, through piping system 310 into inlet manifold 312 of cell stack 300, and correspondingly vented as shown in FIGS. 3 and 4. Piping system 310 can comprise one or more fluid connecting devices, e.g., tubes, conduits, elbows, and the like, for connecting the components of a system. The interface between cathode 306 and piping system 310 through inlet manifold 312 is shown in phantom lines in FIG. 5. Inlet manifold 312 can distribute fuel, such as fluidized zinc pellets, to the anode beds of the cells via filling tubes 314. Thus, any hydrogen gas generated in fuel cell stack 300 can be reacted with a catalyst as described with respect to FIGS. 3 and 4.

The fuel and electrolyte can flow through a flow path 316 in each cell. In some embodiments, the method of delivering the fuel to each cell is a flow through method. For example, a dilute stream of fuel pellets in an electrolyte can be delivered to flow path 316 at the top of each cell via filling tubes 314. The stream can flow through path 316, across anode bed 318, and exit on the opposite side of the cell via outlet tube 320. In some embodiments, pumps 322 can be used to control the flow rate of fuel and electrolyte through cell stack 300.

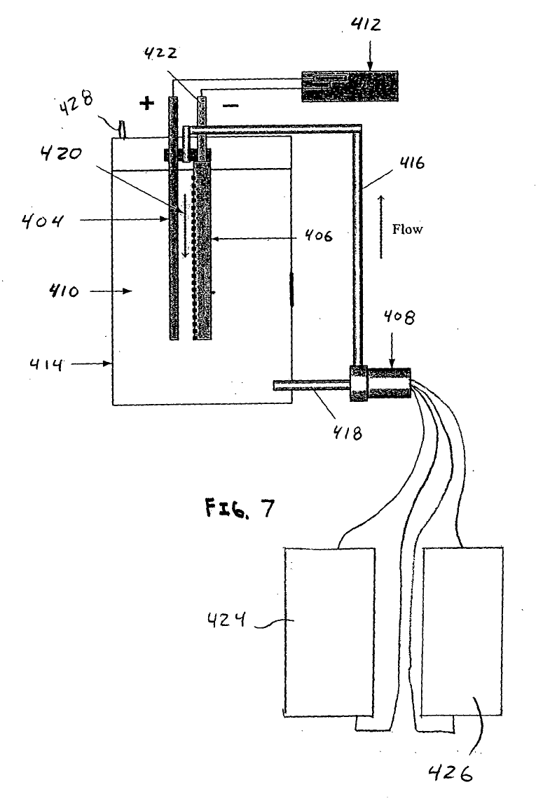

FIG. 6 displays a positive oxygen electrode/cathode 306 within one cell 302 of cell stack 300 of FIG. 5. A non-porous divider 360 separates gas inflow from air blowers 324 from air outlets 326. Stack container 304 forms an inlet chamber 362 and an outlet chamber 364. Inlet chamber 362 and outlet chamber 364, respectively, form passageways from positive oxygen electrode 306 to air blowers 324 and air outlets 326. A gas permeable membrane or backing layer 366 can be placed between air chambers 362, 364 and electrode 306 to reduce or prevent loss of electrolyte through flow out of the cell and/or evaporation. Fuel cell stacks are described further in co-pending application Ser. No. 10/437,481, filed on May 14, 2003, entitled “Combined Fuel Cell and Battery,” which is incorporated herein by reference.

In some embodiments, the metal/air fuel cell system and/or a fuel storage container can comprise a zinc electrolyzer having regeneration electrodes, which can reprocess the above noted reaction products to yield, for example, oxygen and zinc particles. In embodiments employing a zinc fuel, the reaction product Zn(OH)₄²⁻ and/or possibly ZnO or other zinc compounds, can be reprocessed with the application of an external electric potential, for example, from line voltage, to yield molecular oxygen and zinc particles. As described previously, the regeneration electrodes can be located inside a fuel storage container, such as the containers described above, to provide oxygen to react with any hydrogen gas present in the container. Alternatively, the regeneration electrodes can be located in a stand alone container, and regenerated oxygen can be supplied to fuel storage container via a pipe or other suitable connection. Thus, the regeneration electrodes can primarily be used to form oxygen to react with hydrogen, or primarily to regenerate desired amounts of metal fuel with a portion of the resulting oxygen gas being available for reaction with hydrogen gas.

Referring to FIG. 7, container 414 is shown comprising regeneration electrodes 404, 406 suitable for generating molecular oxygen from oxidized metal compounds. In this embodiment, container 414 comprises an anode 404, a cathode 406, a pump 408 and a power supply 412. In some embodiments, anode 404 and cathode 406 can be electrodes which are at least partially immersed in solution 410. Generally, anode 404 and cathode 406 are aligned parallel to each other in container 414 such that adjacent surfaces of anode 404 and cathode 406 define a space where the regeneration reactions can occur. Container 414 generally holds solution 410 as well as anode 404 and cathode 406. In some embodiments, container 414 can be a fuel and electrolyte storage container connected to a electrochemical cell stack to provide fuel and electrolyte to the cell stack. Solution 410 generally is aqueous, although organic solvents, such as alcohols, can be substituted for an aqueous solvent. In one embodiment, solution 410 can comprise zincate ions, Zn(OH)₄²⁻, or dissolved/dispersed ZnO. The zincate ions can be produced by the above mentioned electrochemical reactions which, in one embodiment, can occur in a zinc/air (oxygen) cell. In alternative embodiments, container 414 can comprise a plurality of electrode pairs, which can be connected in parallel or in series.

Metal particles, for example, zinc particles, and molecular oxygen can be produced through electrolysis, which in one embodiment occurs in the space between a surface of anode 404 and the opposing surface of cathode 406. During operation, anode 404 and cathode 406 can be coupled, respectively, to the positive and negative terminals of power supply 412. In some embodiments, a pump 408 can be provided to circulate solution 410 into and out of container 414. In general, pump 408 can be any mechanical device capable of circulating fluids. In one embodiment, as shown in FIG. 7, solution 410 can flow into container 414 through flow inlet 416, and can flow out of container 414 through flow outlet 418. Generally, by pumping solution 410 into and out of container 414 a flow path 420 can be created along the surface of cathode 406.

Suitable regeneration units and their operation are discussed further in copending U.S. application Ser. No. 10/424,539 to Smedley et al. filed on Apr. 24, 2003, entitled “Discrete Particle Electrolyzer Cathode And Method Of Making Same,” incorporated herein by reference.

The embodiments above are intended to be illustrative and not limiting. Additional embodiments are within the claims. Although the present invention has been described with reference to particular embodiments, workers in the art will recognize that changes may be made in form and detail without departing form the spirit and scope of the invention.

We claim:

1. A hydrogen management system comprising:
a container having therein metal particles in contact with an aqueous electrolyte;
a recombination catalyst separate from the aqueous electrolyte in vapor communication with the container, the catalyst catalyzing the reaction of hydrogen and oxygen to form water; and
an oxygen source connected to the container that provides oxygen to the interior of the container, wherein hydrogen gas present in the container can contact the recombination catalyst and combine with oxygen to form water.

2. The hydrogen management system of claim 1 wherein the metal comprises zinc, an alloy of zinc or a combination thereof.

3. The hydrogen management system of claim 1 wherein the metal comprises aluminum, lithium, magnesium, or a combination thereof.

4. The hydrogen management system of claim 1 wherein the recombination catalyst comprises metal selected from the group consisting of platinum, palladium, nickel and combinations thereof.

5. The hydrogen management system of claim 1 wherein the recombination catalyst is located along a top surface of the container.

6. The hydrogen management system of claim 1 wherein the container further comprises a cavity along a top wall of the container, and wherein the cavity comprises the recombination catalyst.

7. The hydrogen management system of claim 1 wherein the container further comprises a vent that can be selectively opened to release gases present inside the container.

8. The hydrogen management system of claim 7 wherein the recombination catalyst is located in at least a portion of the vent.

9. The hydrogen management system of claim 1 wherein the recombination catalyst is separated from the aqueous electrolyte by a head space.

10. The hydrogen management system of claim 1 wherein the oxygen source comprises a valve that allows controlled introduction of ambient air into the container.

11. The hydrogen management system of claim 1 wherein the oxygen source comprises a zinc electrolyzer.

12. The hydrogen management system of claim 1 wherein the oxygen source comprises an oxygen container

13. The hydrogen management system of claim 1 wherein the container further comprises at least one flow inlet and at least one flow outlet for circulating the aqueous electrolyte to other components of an electrochemical cell system.

14. The hydrogen management system of claim 1 further comprising a pump associated with the oxygen source for pumping oxygen into the container.

15. A fuel cell system comprising:
an electrochemical cell stack comprising an anode, a cathode, and a separator between the anode and the cathode;
a container having therein a non-hydrogen fuel suitable for electrochemical reactions in contact with an aqueous electrolyte, wherein the container comprises a flow inlet and a flow outlet coupled to the electrochemical cell stack to provide the non-hydrogen fuel and the electrolyte to the electrochemical cell stack;
a recombination catalyst located in the container, the catalyst catalyzing the reaction of hydrogen and oxygen to form water; and
an oxygen source connected to the storage container such that oxygen can be supplied to container, wherein recombination catalyst is separate from the aqueous electrolyte and wherein the recombination catalyst is positioned in the container such that hydrogen gas present in the container can contact the recombination catalyst and combine with oxygen to form water.

16. The fuel cell of claim 15 wherein the non-hydrogen fuel comprises zinc, an alloy of zinc or a combination thereof.

17. The fuel cell of claim 15 wherein the non-hydrogen fuel comprises aluminum, lithium, magnesium or a combination thereof.

18. The fuel cell of claim 15 wherein the recombination catalyst comprises metal selected from the group consisting of platinum, palladium, nickel and combinations thereof.

19. The fuel cell of claim 15 wherein the oxygen source comprises a member selected from the group consisting of a valve that allows controlled introduction of ambient air into the container, a zinc electrolyzer, and combinations thereof.

20. The fuel cell of claim 15 wherein the zinc electrolyzer is located inside the container.

21. The fuel cell of claim 15 wherein the zinc electrolyzer is separate from the container and oxygen generated by the zinc electrolyzer is supplied to the container though a connection.

22. A method for managing hydrogen in a fuel container for an electrochemical cell system, the method comprising:
reacting hydrogen gas with oxygen gas to form water, wherein a container comprises a non-hydrogen fuel and an electrolyte and wherein a recombination catalyst that catalyzes the reaction of hydrogen and oxygen to form water is in gas communication with the container.

23. The method of claim 22 wherein the container further comprises a temperature sensor.

24. The method of claim 23 wherein the oxygen is supplied at approximately the same rate as the predicted rate of hydrogen evolution at a particular temperature.

25. The method of claim 22 wherein the oxygen is continuously supplied to the container.

26. The method of claim 22 wherein the oxygen is intermittently supplied to the container.
